(19) United States
(12) Patent Application Publication
(10) Pub. No.: US 2004/0230693 A1
(43) Pub. Date: Nov. 18, 2004

(54) Method and device for data transmission

(75) Inventors: Jurgen Baus, Eggenstein-Leopoldshafen (DE); Rolf-Dieter Pavlik, Erlangen (DE); Gernot Rossi, Simmelsdorf (DE); Frank Volkmann, Nurnberg (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/822,224

(22) Filed: Apr. 9, 2004

(30) Foreign Application Priority Data
Apr. 9, 2003 (DE) 103 16 289.5

(51) Int. Cl. G06F 15/16

(52) U.S. Cl. 709/230; 709/218

(57) ABSTRACT

In a method for data transmission for allowing access from a remote unit to at least one automation device via a standard browser, data are transmitted between the remote unit and the automation device(s) via an interconnected data conversion unit. The automation device(s) and the data conversion unit exchange data according to a first communication protocol. The data conversion unit and the remote unit exchange data according to a second communication protocol. The data conversion unit converts the data from the first communication protocol to the second communication protocol.

### CROSS-REFERENCES TO RELATED APPLICATIONS

This application claims the priority of German Patent Application, Serial No. 103 16 289.5, filed Apr. 9, 2003, pursuant to 35 U.S.C. 119(a)-(d), the disclosure of which is incorporated herein by reference.

### BACKGROUND OF THE INVENTION

The present invention relates to a method and a device for data transmission, in particular for data transmission in environments using different transmission protocols.

Improvements in the automation technology increasingly demand access to automation devices from a remote unit via a standard browser. A standard browser can include, for example, the Internet Explorer™, while the automation device can be a stored-program controller (SPC). Web servers integrated in an automation environment are described, for example, in U.S. Pat. Nos. 6,282,454, 6,061,603, or U.S. Pat. No. 5,805,442. The Web servers disclosed therein, however, operate with manufacturer-specific or product-specific protocols and do not allow a standard browser to directly access automation devices.

It would therefore be desirable and advantageous to provide a novel device for data transmission and a method for using such device, which obviates prior art shortcomings and is able to allow standard browsers to seamlessly communicate with automation devices.

### SUMMARY OF THE INVENTION

According to one aspect of the present invention, a method for data transmission to access from a remote unit via a standard browser at least one automation device, includes the steps of transmitting the data between the remote unit and the automation device(s) by connecting a data conversion unit therebetween, exchanging the data between an automation device and the data conversion unit and among the automation devices according to a first communication protocol, exchanging the data between the data conversion unit and the remote unit according to a second communication protocol, and converting with the data conversion unit the data according to the first communication protocol into the data according to the second communication protocol.

The method of the invention for data transmission allows access to one or more automation devices from a remote unit by a standard web server. This approach obviates the need to install a Web server on the automation devices or automation units. The method of the present invention, on one hand, meets the requirements for a communication protocol in the automation environment, and, on the other hand, enables convenient conversion of the communication protocol used in the automation environment to the requirements of the Internet communication protocol.

According to another aspect of the invention, a method for data transmission to access from a remote unit via a standard browser at least one automation device includes the steps of transmitting the data between the remote unit and the automation device(s) by connecting a data conversion unit therebetween, and exchanging the data between the automation device(s) and the data conversion unit and among the automation devices according to a first communication protocol. The first communication protocol enables both markup data transmission and a binary data transmission, wherein the devices between which data are exchanged decide at the beginning of the data transmission automatically if the markup data transmission or the binary data transmission is to be used. The method further includes the steps of exchanging the data between the data conversion unit and the remote unit according to a second communication protocol, and causing the data conversion unit to convert the data according to the first communication protocol into the data according to the second communication protocol.

According to yet another aspect of the invention, a method for data transmission to access from a remote unit via a standard browser at least one automation device includes the steps of transmitting the data between the remote unit and the automation device(s) by connecting a data conversion unit therebetween, exchanging the data between the at least one automation device and the data conversion unit and among the automation devices according to a first communication protocol, and exchanging the data between the data conversion unit and the remote unit according to a second communication protocol. The method further includes the steps of causing the data conversion unit to convert the data according to the first communication protocol into the data according to the second communication protocol; and transmitting quality data with the first transmission protocol, and deciding based on the quality data how data are to be transmitted between the data conversion unit and the remote unit with the second communication protocol.

According to still another aspect of the invention, a data transmission device for accessing from a remote unit at least one automation device via a standard browser includes a data conversion unit connected between the remote unit and at least one automation device and configured to convert data between a first communication protocol and a second communication protocol. Data are exchanged between an automation device and the data conversion unit and among different automation devices by using the first communication protocol, whereas data are exchanged between the data conversion unit and the remote unit according to the second communication protocol.

Embodiments of the invention may include one or more of the following features. The markup data transmission and the binary data transmission of the first communication protocol may be instruction-based. The markup data transmission can be converted into the binary data transmission and the binary data transmission can be converted into the markup data transmission. However, data between the automation devices are preferably exchanged by using the binary data transmission of the first communication protocol. Conversely, data between the automation device(s) and the data conversion unit are preferably exchanged by using the markup data transmission of the first communication protocol. The second communication protocol can be a Web-based, instruction-based protocol.

### BRIEF DESCRIPTION OF THE DRAWING

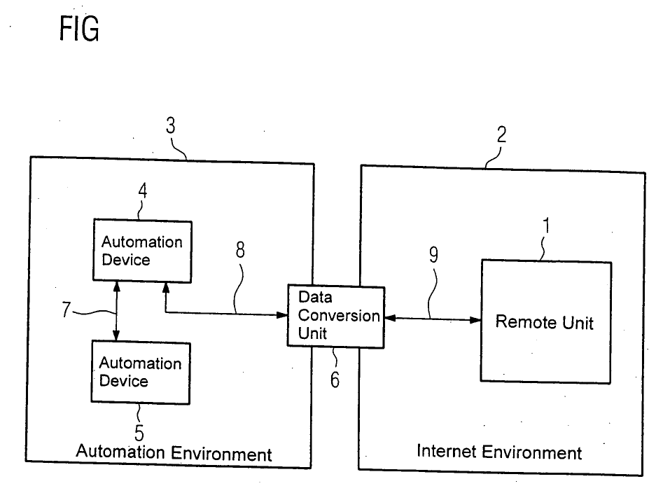

Other features and advantages of the present invention will be more readily apparent upon reading the following description of currently preferred exemplified embodiments of the invention with reference to the accompanying drawing, in which the sole FIG. 1 is a schematic high-level block diagram of the device for data transmission in accordance with to the invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application is hereby expressly incorporated by reference: “METHOD AND DEVICE FOR DATA TRANSMISSION”.

Turning now to the FIGURE, there is shown a schematic high-level block diagram of the device according to the invention. The FIGURE shows a remote unit 1, associated with an Internet environment 2. In the depicted exemplary embodiment, two automation units 4, 5 are associated with an automation environment 3, wherein the two automation units 4, 5 in the depicted embodiments can be implemented as stored-program controllers (SPC). However, the automation devices 4, 5 can also include CNC units, drives or another type of unit suitable to automate industrial processes.

According to the present invention, the remote unit 1 accesses the automation devices 4, 5 via a standard browser, for example the Internet Explorer™, and exchanges data with the automation units 4, 5. Standard browsers may also includes Netscape, Mozilla, Opera, and the like. A data conversion unit 6, also referred to as an agent, is connected between the remote unit 1 and the automation devices 4, 5. The data conversion unit 6 therefore enables data exchange between the automation units 4, 5 associated with the automation environment 3 and the remote unit 1 associated with the Internet environment 2.

The automation devices 4, 5 associated with the automation environment 3 exchange, on one hand, data with each other, as indicated by the arrow 7, and, on the other hand, exchange data with the data conversion unit 6, as indicated by the arrow 8. The data exchange indicated by the arrows 7 and 8, i.e., the data exchange among the units associated with the automation environment 3, is implemented with a first communication protocol.

This first communication protocol is a time-optimized transmission protocol with a high throughput rate for useful data and a low protocol overhead. The first communication protocol is capable of transmitting markup data as well as binary data. When the data transmission between two devices or units begins, for example, when data are transmitted at the beginning of the transmission in the embodiment depicted in the FIGURE (indicated by the arrows 7 and 8, respectively), the units 4 and 5, or 4 and 6, decide automatically, if a markup data transmission protocol or a binary data transmission protocol are is used in the data exchange according to the first communication protocol.

It should be pointed out that the markup data transmission and the binary data transmission are configured in the first communication protocol so that fast mapping between the markup data transmission and the binary data transmission is enabled. This can be achieved because the binary data transmission differs from the markup data transmission only by the so-called syntax. In all other aspects, the two data transmission types within the first communication protocol are identical. The units participating in the data exchange, i.e., the transmitter and the receiver, therefore agree at the start of the data transmission if the binary or a text-based data transport is selected.

It should be noted that binary data transmission is preferred if data are to be exchanged between the two automation devices 4, 5, because binary data transmission accelerates the data exchange and this plane does not require conversion into another data transmission protocol. However, if data are to be exchanged between the automation device 4 and the data conversion unit 6, then the markup data transmission is preferred within the first communication protocol. This makes it easier for the data conversion device 6 to convert the data to a second communication protocol used for data exchange between the data conversion unit 6 as a remote unit 1, as indicated by the arrow 9. The second communication protocol, which is used for data transmission between the data conversion unit 6 and the remote unit 1, can be a standard protocol for a Web-based data transport, preferably an HTTP protocol.

It should be noted in the context of the first communication protocol, which is used, on one hand, for data exchange among the automation devices 4, 5 and, on the other hand, for data exchange between the automation device 4 and the data conversion unit 6, that both the markup data transmission and the binary data transmission are instruction-based. Accordingly, both the markup data transmission and the binary data transmission are extendable and therefore upwards compatible. In order to ensure clarity throughout the disclosure, the term “Instruction-based” means that during data transmission, a sequence of instructions is transmitted first, with the parameters of the instructions being transmitted at a later time. In binary data transmissions, the instruction is a bit sequence, in the markup data transmission the instruction is a markup tag.

It is also desirable with the present invention to transmit quality data in conjunction with the first communication protocol. The transmission of quality data as a component of the communication protocol is proposed herein for the first time and has not been reported in publicly accessible publications. Quality data are transmitted in both markup data transmission and in binary data transmission using the first communication protocol. Quality data are defined as information in addition to the data to be transmitted and can be, for example, values of the data to be transmitted and/or information about the significance and/or urgency of the data. Urgency of information is meant to indicate how quickly data have to be available in the remote unit 1.

These quality data are used, inter alia, by the data conversion unit to decide how to perform the data transmission between the data conversion unit 6 and the remote unit 1. For example, a so-called simple Polling or a so-called endless HTML page or a bidirectional HTTP communication can be used, depending on the importance and/or urgency of the data that are to be transmitted with the second communication protocol, which allows data transmission between the data conversion unit 6 and the remote unit 1. The aforementioned transmission protocols are familiar to a person skilled in the art. A bidirectional HTTP communication is described, for example, in German Pat. No. DE 199 04 331 C1. The data conversion unit 6 therefore decides automatically based on the transmitted quality data which of the afore-described transmission protocols to use. The quality data therefore represent a decision aid for the data conversion unit 6.

As mentioned above, the entire data transmission is time-optimized and readily expandable. The bidirectional data transmission in the automation environment 3 can be easily converted to a unidirectional data transmission in the Internet environment. In addition, data transmission can occur in real time. Real-time capability is essentially a consequence of providing the binary data transmission in the first communication protocol. The data transmission can be operated in parallel with a so-called Hard-Real-Time-Ethernet or a so-called Soft-Real-Time-Ethernet. This property is inherent in the afore-described features of the method of the invention.

It should also be noted in the context of the method of the present invention for data transmission that in the first communication protocol, which is provided for data transmission among the automation devices 4, 5 themselves and for data transmission between the automation devices 4, 5 and the data conversion unit 6, that safety mechanisms for encrypting, authentication and access control can also be integrated. These safety mechanisms can be implemented in both the markup data transmission and the binary data transmission as markup instructions and binary instructions, respectively.

The present invention therefore enables access to automation devices from an Internet environment and/or a remote unit by using a standard browser, which obviates the need to rely on manufacturer-specific or product-specific solutions.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for data transmission to access from a remote unit via a standard browser at least one automation device, comprising the steps of:
a) transmitting the data between the remote unit and the at least one automation device by connecting a data conversion unit therebetween;
b) exchanging the data between the at least one automation device and the data conversion unit and between the automation devices according to a first communication protocol;
c) exchanging the data between the data conversion unit and the remote unit according to a second communication protocol; and
d) causing the data conversion unit to convert the data according to the first communication protocol into the data according to the second communication protocol.

2. The method of claim 1, wherein the first communication protocol enables both markup data transmission and binary data transmission, wherein the devices and units between which data are exchanged decide at the beginning of the data transmission automatically if the data are to be transmitted by markup data transmission or by binary data transmission.

3. The method of claim 2, wherein both the markup data transmission and the binary data transmission of the first communication protocol are instruction-based.

4. The method of claim 2, wherein the markup data transmission can be converted into the binary data transmission and the binary data transmission can be converted into the markup data transmission.

5. The method of claim 2, wherein the data are exchanged between the automation devices by using the binary data transmission of the first communication protocol.

6. The method of claim 2, wherein the data are exchanged between the at least one automation device and the data conversion unit preferably by using the markup data transmission of the first communication protocol.

7. The method of claim 1, wherein quality data are transmitted both in markup data transmission and in binary data transmission, with the quality data determining if the data are to be transmitted between the data conversion unit and the remote unit in markup data transmission and in binary data transmission.

8. The method of claim 1, wherein the second communication protocol is a Web-based, instruction-based protocol.

9. A method for data transmission to access from a remote unit via a standard browser at least one automation device, comprising the steps of:
a) transmitting the data between the remote unit and the at least one automation device by connecting a data conversion unit therebetween;
b) exchanging the data between the at least one automation device and the data conversion unit and between the automation devices according to a first communication protocol, wherein the first communication protocol enables both markup data transmission and a binary data transmission, wherein the devices between which data are exchanged decide at the beginning of the data transmission automatically if the markup data transmission or the binary data transmission is to be used;
c) exchanging the data between the data conversion unit and the remote unit according to a second communication protocol; and
d) causing the data conversion unit to convert the data according to the first communication protocol into the data according to the second communication protocol.

10. The method of claim 9, wherein both the markup data transmission and the binary data transmission of the first communication protocol are instruction-based.

11. The method of claim 9, wherein the markup data transmission can be converted into the binary data transmission and the binary data transmission can be converted into the markup data transmission.

12. The method of claim 9, wherein the data are exchanged between the automation devices by using the binary data transmission of the first communication protocol.

13. The method of claim 9, wherein the data are exchanged between the at least one automation device and the data conversion unit by using the markup data transmission of the first communication protocol.

14. The method of claim 9, wherein quality data are transmitted both in markup data transmission and in binary data transmission, with the quality data determining if the data are to be transmitted between the data conversion unit and the remote unit in markup data transmission and in binary data transmission.

15. The method of claim 9, wherein the second communication protocol is a Web-based, instruction-based protocol.

16. A method for data transmission to access from a remote unit via a standard browser at least one automation device, comprising the steps of:
a) transmitting the data between the remote unit and the at least one automation device by connecting a data conversion unit therebetween;
b) exchanging the data between the at least one automation device and the data conversion unit and between the automation devices according to a first communication protocol;
c) exchanging the data between the data conversion unit and the remote unit according to a second communication protocol;
d) causing the data conversion unit to convert the data according to the first communication protocol into the data according to the second communication protocol; and
e) transmitting quality data in the first transmission protocol, and deciding based on the quality data how data are to be transmitted between the data conversion unit and the remote unit by using the second communication protocol.

17. The method according to claim 16, wherein the first communication protocol enables both markup data transmission and binary data transmission, wherein the automation devices and the data conversion unit between which data are exchanged decide at the beginning of the data transmission automatically if the data are to be transmitted by markup data transmission or by binary data transmission.

18. The method of claim 16, wherein both the markup data transmission and the binary data transmission of the first communication protocol are instruction-based.

19. The method of claim 16, wherein the markup data transmission can be converted into the binary data transmission and the binary data transmission can be converted into the markup data transmission.

20. The method of claim 16, wherein the data are exchanged between the automation devices by using the binary data transmission of the first communication protocol.

21. The method of claim 16, wherein the data are exchanged between the at least one automation device and the data conversion unit by using the markup data transmission of the first communication protocol.

22. The method of claim 16, wherein the second communication protocol is a Web-based, instruction-based protocol.

23. A data transmission device for accessing from a remote unit at least one automation device via a standard browser, comprising a data conversion unit connected between the remote unit and at least one automation device and configured to convert data between a first communication protocol and a second communication protocol, wherein the data are exchanged between the at least one automation device and the data conversion unit and among the automation devices by using the first communication protocol, and wherein the data are exchanged between the data conversion unit and the remote unit according to a second communication protocol.
